(19) United States
(12) Patent Application Publication
(10) Pub. No.: US 2023/0420193 A1
(43) Pub. Date: Dec. 28, 2023

(54) PSEUDOCAPACITIVE BATTERY

(71) Applicant: THE ROYAL INSTITUTION FOR THE ADVANCEMENT OF LEARNING / MCGILL UNIVERSITY, Montréal (CA)

(72) Inventors: Kirk H. BEVAN, Verdun (CA); Yee Wei FOONG, Montreal (CA); Shuaishuai YUAN, Montreal (CA); Javad SHIRANI, Montreal (CA); Christopher A. HOWARD, London (GB)

(21) Appl. No.: 18/213,081

(22) Filed: Jun. 22, 2023

Related U.S. Application Data
(60) Provisional application No. 63/354,325, filed on Jun. 22, 2022.

(51) Int. Cl. H01G 11/36; H01G 11/56; H01G 11/58; H01G 11/52; H01G 11/86

(52) U.S. Cl. CPC H01G 11/36; H01G 11/56; H01G 11/58; H01G 11/52; H01G 11/86; B82Y 30/00

(57) ABSTRACT

There is provided an energy storage device, comprising a first electrode having a plurality of electrons stored thereon, a second electrode having a plurality of holes stored thereon, the second electrode spaced from the first electrode to define a volume therebetween, a supporting medium disposed in the volume between the first electrode and the second electrode, the supporting medium comprising at least one counterion species, and a plurality of nanoparticle elements provided in the volume, adjacent at least one of the first electrode and the second electrode, the plurality of nanoparticle elements configured to store the electrons therein at different energy levels using quantized capacitance.

### CROSS-REFERENCE TO RELATED APPLICATIONS

The present application claims the benefit of U.S. Provisional Patent Application No. 63/354,325 filed on Jun. 22, 2022, the contents of which are hereby incorporated by reference.

### FIELD

The improvements generally relate to the field of energy storage devices, and more specifically to pseudocapacitive batteries.

### BACKGROUND

Electrochemical capacitors combine both electric double layer (EDL) and Faradaic mechanisms to maintain high power densities, but at energy densities that exceed the performance of purely EDL-based capacitors. This improvement is often accomplished by utilizing redox-active nanoparticles at the electrode surface, which store additional electrons in a Faradaic manner that mimics EDL charge storage “pseudocapacitively.” It is desirable to maintain the high power performance of electrochemical capacitors while pushing towards the energy density regime typically occupied by batteries. A great deal of research is currently focused on realizing a high performance pseudocapacitance energy storage enabled by nanomaterials. However, despite extensive experimental activity, the physics which underlie a pseudocapacitive response in a given nanomaterial system are not well understood. Recently, it was proposed that suitably engineered conducting nanoparticles might be tailored to exhibit a near ideal pseudocapacitive response through the use of “quantized capacitance”—an observable Faradaic mechanism in nanoparticles arising from electron-electron interactions related to Coulomb blockade. However, the energy and power density capabilities of “quantized capacitance” have yet to be fully explored.

Therefore, improvements are needed.

### SUMMARY

In accordance with one aspect, there is provided an energy storage device, comprising a first electrode having a plurality of electrons stored thereon, a second electrode having a plurality of holes stored thereon, the second electrode spaced from the first electrode to define a volume therebetween, a supporting medium disposed in the volume between the first electrode and the second electrode, the supporting medium comprising at least one counterion species, and a plurality of nanoparticle elements provided in the volume, adjacent at least one of the first electrode and the second electrode, the plurality of nanoparticle elements configured to store the electrons therein at different energy levels using quantized capacitance.

In some embodiments, the plurality of nanoparticle elements are made of at least one of carbon, semi-metallic elements, semiconducting elements, and metallic elements.

In some embodiments, each nanoparticle element of the plurality of nanoparticle elements has a size distribution lower than 100 nm.

In some embodiments, each of the first electrode and the second electrode comprises a current collector, and the plurality of nanoparticle elements are deposited onto the current collector of at least one of the first electrode and the second electrode.

In some embodiments, at least one of the first electrode and the second electrode comprises a current collector coated with a conductive material, and the plurality of nanoparticle elements are deposited onto the conductive material.

In some embodiments, the plurality of nanoparticle elements are embedded or dispersed in the supporting medium.

In some embodiments, the supporting medium is one of an electrolytic medium and a dielectric medium.

In some embodiments, the supporting medium is in at least one of a liquid state and a solid state.

In some embodiments, the supporting medium is an immiscible electrolyte.

In some embodiments, the supporting medium is one of static and non-static.

In some embodiments, the plurality of nanoparticle elements are configured to be displaced within the supporting medium.

In some embodiments, the first electrode and the second electrode are printed onto a substrate.

In some embodiments, the first electrode, the second electrode, and the supporting medium are made of a flexible material.

In some embodiments, the plurality of nanoparticle elements are separated from one another by the supporting medium.

In some embodiments, the plurality of nanoparticle elements comprises a first plurality of nanoparticle elements and a second plurality of nanoparticle elements, the energy storage device further comprising a separating member disposed within the volume at a substantially equal distance from the first electrode and the second electrode, the separating member configured to separate the first plurality of nanoparticle elements from the second plurality of nanoparticle elements.

In some embodiments, the energy storage device further comprises a network of conductive material provided within the volume between the first electrode and the second electrode, the plurality of nanoparticle elements distributed within the network of conductive material.

In accordance with another aspect, there is provided a method for providing an energy storage device. The method comprises providing a first electrode having a plurality of electrons stored thereon, providing a second electrode having a plurality of holes stored thereon, spacing the second electrode from the first electrode to define a volume therebetween, disposing a supporting medium in the volume between the first electrode and the second electrode, and providing a plurality of nanoparticle elements in the volume, adjacent at least one of the first electrode and the second electrode, and separated from one another by the supporting medium, the plurality of nanoparticle elements configured to store the electrons therein at different energy levels.

In some embodiments, providing the plurality of nanoparticle elements in the volume comprises depositing the plurality of nanoparticle elements onto a current collector of at least one of the first electrode and the second electrode.

In some embodiments, providing the plurality of nanoparticle elements in the volume comprises depositing the plurality of nanoparticle elements onto a conductive material coated on a current collector of at least one of the first electrode and the second electrode.

In some embodiments, providing the plurality of nanoparticle elements in the volume comprises providing a network of conductive material within the volume, and distributing the plurality of nanoparticle elements within the network of conductive material

Many further features and combinations thereof concerning embodiments described herein will appear to those skilled in the art following a reading of the instant disclosure.

### DESCRIPTION OF THE FIGURES

In the figures,

FIG. 1 is a Ragone plot depicting the volumetric power and energy densities of various energy storage devices, in accordance with one embodiment;

FIG. 2 is a schematic diagram illustrating that the total volume to reactant (e.g., nanodisks) volume can be calculated by taking the ratio of the nanodisk thickness d and the supporting medium thickness L, in accordance with one embodiment;

FIG. 3 is a plot of electron density as a function of the ratio of total volume to reactant (e.g., nanodisks) volume, assuming a surface electron storage density of 4 q/nm² and the corresponding volumetric energy density at 5 V storage voltage, in accordance with one embodiment;

FIG. 4A is a plot of cyclic voltammetry of quantized capacitance up to a maximum applied potential V_{-,max} on a single electrode that resembles an ideal pseudocapacitive behavior due to the overlapping electron transfer peaks, in accordance with one embodiment;

FIG. 4B is a schematic diagram of a single negative (−) electrode depicting the operation of quantized capacitance Faradaic storage via electron tunneling to each reactant state and describing the electron storage at a cathode during the charging process (as the electrode electrochemical potential μ_{eq} is raised), the desired electron density being stored at V_{-,max}, in accordance with one embodiment;

FIG. 5A is a plot illustrating achieving a target single electrode voltage for adding a target density of electrons via quantized capacitance by tuning the dielectric response and nanoparticle radius, where the plot is computed with a target density of electrons of 4 q/nm², in accordance with one embodiment;

FIG. 5B is a plot illustrating the change in parameter U in response to tuning the dielectric response and nanoparticle radius, in accordance with one embodiment;

FIG. 5C is a plot illustrating the change in reorganization energy λ with various dielectric responses and nanoparticle radii, in accordance with one embodiment;

FIG. 6A illustrates comparative electronic structure plots against an electrolyte stability 120 window situated between −2 eV and −7 eV below vacuum, in accordance with one embodiment;

FIG. 6B is a schematic diagram depicting that the position of the open circuit potential (V_{OC}) within the electrolyte stability window dictates the electrode potentials (|V_{anode}| and |V_{cathode}|) and the maximum cell potential Vₘₐₓ for a system with symmetric electrodes, in accordance with one embodiment.

FIG. 6C is a schematic diagram of V_{OC} that lies closer to the limits for positive electrode, in accordance with one embodiment;

FIG. 7A illustrates the |Mᵢₚ| and λ_{c} to achieve a specific electron transfer rate kᵢₚ, ranging from 10⁻³ to 100 s⁻¹, in accordance with one embodiment;

FIG. 7B illustrates the effect of barrier width on the required Mᵢₚ to efficiently store the electrons at various barrier heights V_{b}, in accordance with one embodiment;

FIG. 7C illustrates Dₑ at 300 K as a function of |Mᵢₚ| and λ_{c} for a 2.5 eV tunneling barrier, in accordance with one embodiment;

FIG. 8 is a schematic diagram of an energy storage device using Coulomb blockade, in accordance with one embodiment;

FIG. 9A illustrates a schematic diagram and a cyclic voltammogram of the energy storage device of FIG. 8 using nanodisks, in the fully charged state and during discharging, in accordance with one embodiment;

FIG. 9B illustrates a schematic diagram and a cyclic voltammogram of the redox polymer battery scheme in the fully charged state and during discharging, in accordance with one embodiment;

FIG. 10 is a schematic diagram of an energy storage device using stacked MXene composite layers, in accordance with one embodiment;

FIG. 11A illustrates a schematic diagram of an energy storage device with a supporting medium in a liquid state, in accordance with one embodiment;

FIG. 11B illustrates a schematic diagram of an energy storage device with a supporting medium in a liquid state, in accordance with another embodiment;

FIG. 11C illustrates a schematic diagram of an energy storage device with a supporting medium in a liquid state, in accordance with yet another embodiment;

FIG. 12A illustrates a schematic diagram of an energy storage device with a supporting medium in a solid state, in accordance with one embodiment;

FIG. 12B illustrates a schematic diagram of an energy storage device with a supporting medium in a solid state, in accordance with another embodiment;

FIG. 12C illustrates a schematic diagram of an energy storage device with a supporting medium in a solid state, in accordance with yet another embodiment; and

FIG. 13 is a flowchart of a method for providing an energy storage device, in accordance with one embodiment.

### DETAILED DESCRIPTION

Herein, it is proposed to improve energy density and power density storage capabilities for an electrochemical system, and more particularly provide a combination of high power density and high energy density, making use of quantized capacitance and its pseudocapacitive features. As used herein, the term “energy density” refers to how much energy a given system stores, while the term “power density” refers to how fast the system charges and discharges. The level of energy density and power density achievable by a given system may vary depending on the application.

Using suitably sized engineered nanostructures may allow to boost the energy storage of electrons across a wide voltage range (i.e., with the entire voltage range, whose value may vary depending on the application, being used to store energy) and such energy storage can in turn be employed as a pseudocapacitive battery or in devices such as capacitors, conventional batteries, flow battery designs, and the like. As used herein, the term “pseudocapacitive” refers to the successive storage of charge through multiple electron transfer events (often referred to as Faradaic) in an electrochemical system that mimics the current-voltage properties of a classical capacitor. For instance, a specific application of the energy storage device proposed herein may be to replace the metals in existing energy storage devices with carbon materials during electrode manufacturing, thereby allowing to engineer metal-free batteries and to resolve sustainability challenges. Existing manufacturing processes used for existing battery technology or energy storage systems of similar configuration (e.g., ultracapacitors) may be adapted for application to the energy storage device described herein.

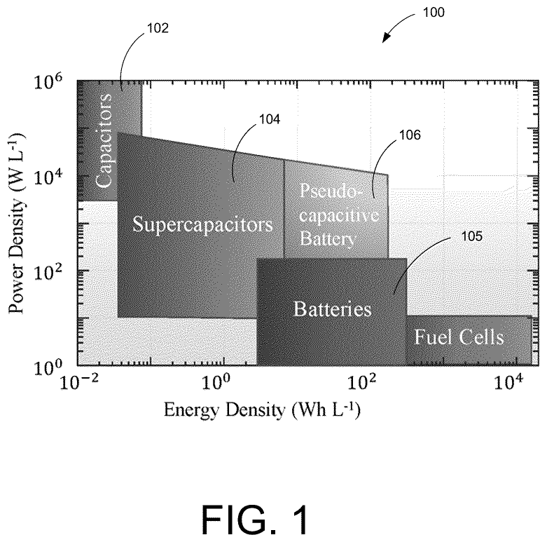

In FIG. 1, the approximate power density and energy density performance of various energy storage technologies are provided in the form of a Ragone plot 100. The highest power density is provided by conventional capacitors (see area 102 on plot 100), though they suffer from very low energy storage density. In supercapacitors, the EDL mechanism is tailored through multiscale nanostructuring to maintain a comparatively high power density while extending towards volumetric energy densities of the order of 10 Wh/L (see area 104 on plot 100). On the other hand, conventional batteries provide much better energy storage than supercapacitors but typically at a much lower power density (see area 105 on plot 100). The driving impetus behind engineering a pseudocapacitive component within an electrochemical capacitor is to maintain the fast charging properties of supercapacitors while extending performance towards the energy densities currently occupied by batteries. This long standing nexus is shown by area 106 on plot 100 of FIG. 1, the specific aim being to assess the degree to which quantized capacitance might be engineered to yield both high power density and high energy density within region 106, resulting in a pseudocapacitive battery.

The investigation is motivated by developments in the usage of graphitic nanoparticles, where these particles have been utilized electrochemically to great effect by tuning both their dimensionality and laminate packing. It has also been shown that carbon nanostructures can store high densities of electrons. Additionally, from a pseudocapacitive perspective, graphite or graphene is a bulk conductor, which through sufficient nanostructuring can provide quantized capacitance charging states that are accessible electrochemically. Moreover, graphitic nanoparticles can be resolved down to one atomic layer such that all atoms equally participate in charge storage. In other words, there is no internal region in such a two-dimensional (2D) material and therefore the charge storage as function solely of the nanoparticle volume is maximized compared to, for example, a conducting sphere, where net charge aggregates towards the surface. Driven by these developments, a quantized capacitance energy storage scheme is proposed herein.

In particular, an energy storage device having at least one of its electrode terminals modified to utilize a mechanism (referred to herein as the “Coulomb blockade” mechanism) is proposed herein. In turn, energy storage of various systems may be enhanced using the systems and methods described herein. As used herein, the term “Coulomb blockade” refers to the energetic quantization of electron addition and removal in suitably sized engineered nanostructured materials. In energy storage devices, electrons are transferred to and stored in the nanostructured materials. Forced to be in close proximity to each other in such nanostructured materials, electrons experience strong mutual repulsion. Hence, the next electron is to be added at a higher voltage level than previous electrons. This leads to a split in the system's energy level (referred to herein as “energy level splitting”) at equal distance over a wide voltage range, allowing for increased electron storage potential within the nanostructured materials. The term “Coulomb blockade” thus refers to the manner in which electrons are stored at different energy levels in the nanostructured materials. As used herein, the term “quantized capacitance” refers to a process via which Coulomb blockade is used to store energy.

In general, the Coulomb blockade mechanism can be realized in a device that stores a matching number of charges on both of its electrode terminals (the charges on both terminals being of opposite polarity), where at least one of the terminals is modified with conducting or semi-conducting nanoparticles or nanostructures (referred to herein as “nanostructured elements” or “nanostructured materials”). As will be described below, it is thus proposed herein to construct at least one of the energy storage device's electrode terminals of conducting or semi-conducting nanostructured elements that utilize the Coulomb blockade mechanism. It is further proposed herein for the energy storage device to include a supporting medium (which may be a dielectric or electrolytic media) in which the nanoparticle elements may be partially or fully embedded, which provide a reorganization response with the addition or removal of electrons from such a nanostructure. The nanostructured elements may also be separated by non-conducting media to allow for electron tunneling and storage, to promote electron-electron interactions in such a nanostructure. As will be described further below, the non-conducting media may be made of a non-conducting material including, but not limited to, a Solid Electrolyte Interphase (SEI) layer, electrolytic media, coating, core-shell, ligand, grafting, or non-conducting layer. The design of the device's electrode and criteria to engineer the device's components will be described further below.

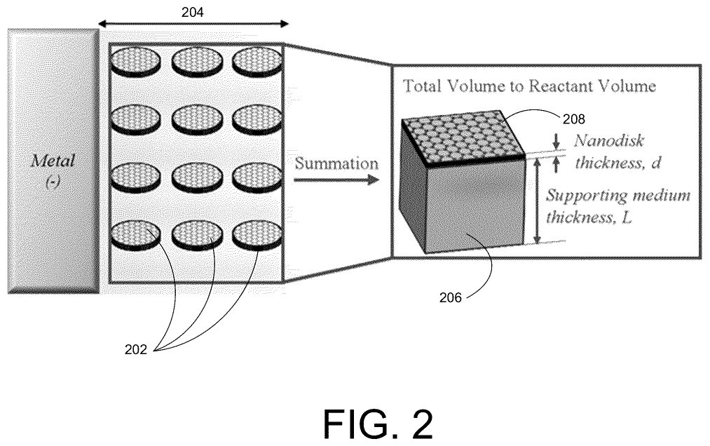

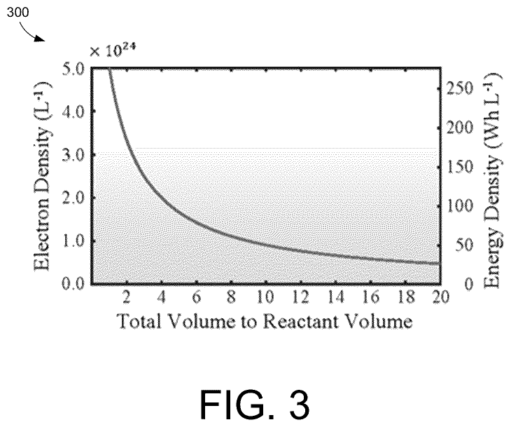

To explore the physical feasibility of a quantized capacitance storage mechanism, the volumetric energy density limits that would be provided by this scheme are first described with reference to FIG. 2 and FIG. 3.

Fundamentally, the volumetric energy storage density of a system is a product of the density at which electrons are stored and the voltage V at which the electrons are placed. In a capacitive system, this is summarized by E=½CV²=½QV, where C is the capacitance and Q is the charge stored (Q=CV). In one embodiment and as illustrated in FIG. 2, nanoscale graphene disks 202 may be provided in nanoparticle layers 204 and used in an energy storage system. The energy storage density is proportional to the number of electrons stored in such nanodisks 202. Although energy storage designs are discussed herein within the context of a graphitic nanodisk-based system, the approach discussed herein can also be applied to a range of similar nanomaterials, i.e. all nanomaterials that can be used to achieve Coulomb blockade. However, nanodisks as in 202 are likely advantageous as they utilize a minimal amount of pseudocapacitive volume to store charge (having no “interior region”, for example compared to spherical nanoparticles).

Nanoscale graphitic systems can store one (1) electron for approximately every ten (10)_carbon atoms. This achievable ratio, when applied to graphene or graphene nanodisks as in 202, results in a surface electron storage density of σₑ≈4 q/nm², where q=1.6×10⁻¹⁹ C is the elementary charge. Although this electron density is less than the theoretical maximum of fully intercalated graphite in batteries, it is still a significant storage density for supercapacitor systems. To induce quantized capacitance, it is desirable for a nanoparticle to be separated from other similar particles by a supporting medium 206 (also referred to herein as an “electrically insulating medium”), since this promotes electron-electron interactions and enables one to tune the storage voltage. The dielectric properties of the insulating medium 206, which may be a dielectric media or an electrolyte, also impact the voltage storage properties associated with quantized capacitance, as will also be discussed further below. The supporting medium 206 can be as thin as 1 nm. Thus, when combining the proposed graphene nanodisks 202 with a supporting medium 206 separating the nanodisks 202, one obtains the electron density trend presented in plot 300 of FIG. 3.

It is desirable for the electrolyte fraction present in the porous electrode to be assessed because, to arrive at a plausible energy storage technology, it is desirable for the packing density of nanoparticles to be increased (compared to existing approaches). This is desirable to increase volumetric energy densities via the energy storage mechanism proposed herein, similar to the manner in which it is desirable to increase the molar concentration of redox species to increase the volumetric energy density in a flow battery. An effective thickness (d) for a graphene nanodisk as in 202 corresponding to d≈0.4 nm, roughly equal to the spacing between graphite sheets, is assumed, and the total volume is varied from 2 times to 20 times the reactant (nanodisks) volume. Accordingly, at a storage voltage of V_{d}=5 V, one obtains the volumetric energy density trends presented in plot 300 of FIG. 3 that can be described by:

$${E}_{d} = \frac{1}{4} ( \frac{{q V}_{d} {σ}_{e}}{d + L} ) \qquad ( 1 )$$

where L is the thickness of the supporting medium region relative to the disk region—a parameter obtainable by summing all the nanodisks 202 as a single surface 208 and placing the surface 208 atop the volume of the supporting medium 206 normalized to the same surface area (see FIG. 2).

It is noted that a factor of ¼, being the product of two ½ multipliers, is appended to the energy density expression in Eq. (1). The first ½ multiplier from the equal volume of opposite charge that is to be stored at a cathode of the energy storage device. The second ½ multiplier arises from the manner in which charge is stored via quantized capacitance, being added in equal degrees at higher and lower voltages for a given terminal, just like a regular capacitor. From the plot 300 of FIG. 3, it can be seen that, when half of the supporting medium's volume is electroactive, the upper Ragone energy density limit of about 250 Wh/L is obtained for quantized capacitance as shown in FIG. 1. On the other hand, the energy density is significantly degraded when the overall volume is 20 times greater than the electroactive contribution, leading to the lower limit provided in FIG. 1. The higher extreme of about 250 Wh/L is likely unrealistic and the lower limit is likely impractical, but arguably intermediate densities around 100 Wh/L are achievable, as will be discussed further below.

An overview on the mechanism giving rise to quantized capacitance (i.e. referred to herein as the “quantized capacitance redox mechanism”) will now be provided. The primary energy density assumption is that the redox potentials of nanoparticles exhibiting quantized capacitance can be pushed towards encompassing a bias window of near 5 V. This is arguably the maximum achievable bias window for most state-of-the-art electrolyte systems. The manner in which energy storage at this voltage limit of near 5 V may be accomplished via quantized capacitance will now be described.

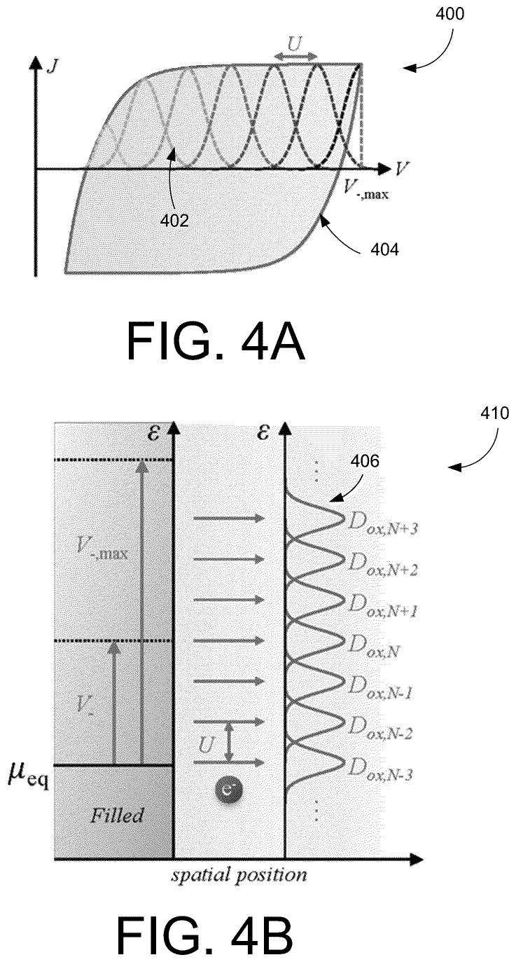

When an electrode is biased towards electron storage, the potential difference will raise the Fermi energy level in the electrode relative to nanoparticles in the electrolyte, as shown in FIGS. 4A-B. This bias will then initiate electron transfer into the unoccupied electronic states present in the nanoparticles (see FIG. 4B). Because of the limited size of the nanoparticles, each electron being added will experience measurable electron-electron repulsion, leading to the initial charging energy cost Uₒ that constitutes quantized capacitive behavior. For a nanodisk, this charging energy cost Uₒ can be approximately expressed as:

$${U}_{o} = \frac{{q}^{2}}{2 {πϵ}_{op} {ϵ}_{o} r} F ( r ) \qquad ( 2 )$$

where ϵₒ is the permittivity of vacuum, ϵₒₚ is the optical dielectric constant, and r is the nanoparticle radius or size. The function F (r) accounts for the average electrostatic potential across a uniformly charged disk. After solvent reorganization, the placement of the electron reduces to U, which includes orientational dielectric contributions present in liquid electrolyte:

$$U = \frac{{q}^{2}}{2 {πϵ}_{r} {ϵ}_{o} r} F ( r ) \qquad ( 3 )$$

$$= {U}_{o} - 2 λ \qquad ( 4 )$$

where U is the size-dependent charging energy cost leading to the energy level quantization in Coulomb blockade mechanism, ϵᵣ is the relative permittivity of the electrolyte, and λ is the heterogeneous reorganization energy. Although equation (3) is specific to nanoparticles that are configured as nanodisks, it should be understood that other configurations may apply, as discussed further herein. As such, the charging costs equation (3) may vary depending on the configuration (e.g., shape, size, type) of the nanoparticles. As a result of these interactions, a voltammetric scan will exhibit multiple overlapping electron transfer current peaks separated by U—shown as dashed lines 402 in plot 400 of FIG. 4A. By carefully engineering U, one can physically tailor the individual redox peaks to sufficient overlap with each other such that a near-rectangular voltammetry profile for pseudocapacitive energy storage behavior is enabled (see solid line 404 in plot 400 of FIG. 4A).

A tunneling electron transfer process between the electrode and nanoparticle dispersion is considered. Hence, the Coulomb blockade mechanism of multiple electron storage in a dielectric medium can be described by the Gerischer-Hopfield model and the multiple redox peaks as in 406 presented in plot 410 of FIG. 4B can each be described within Gerischer-Hopfield theory. The N^{th} electron tunnels within the nanostructured materials from a filled density of states of the N^{th} level (D_{ox,N}(ε)) to an empty density of states of the N+1^{th} level (D_{red,N+1}(ε)). Each electron transfer event into a nanoparticle with N electrons is then described by the oxidation distribution as follows:

$${D}_{ox , N} ( ε ) = \frac{1}{\sqrt{4 π λ {k}_{B} T}} exp ( \frac{- {( ε - {ε}_{ox , N} )}^{2}}{4 λ {k}_{B} T} ) \qquad ( 5 )$$

where ε is the single-particle energy found in the Gerischer-Hopfield framework. Likewise, an electron removal event from a nanoparticle with N electrons occurs via:

$${D}_{red , N + 1} ( ε ) = \frac{1}{\sqrt{4 π λ {k}_{B} T}} exp ( \frac{- {( ε - {ε}_{red , N + 1} )}^{2}}{4 λ {k}_{B} T} ) \qquad ( 6 )$$

where k_{B} is the Boltzmann constant and T is the temperature. Moreover, ε_{ox,N} is the single-particle energy level of the N^{th} oxidized state and ε_{red,N+1} is the single-particle energy level of the N+1^{th} reduced state.

Equations (5) and (6) thus express the density of electronic states for successive redox events.

The single-particle redox levels are then related by:

ε_{red,N+1}−ε_{red,N}=U

ε_{ox,N}−ε_{red,N+1}=2λ (7)

It is assumed that wavefunction quantization contributions to the total energy arising from an electron addition or removal event are negligible. Crucially, one can engineer A and U to tune the redox peak placement in a quantized capacitance system to encompass a target V_{-,max} placement voltage for a given number of electrons (see FIG. 4B). However, overall storage voltage V_{d} of the energy storage system proposed herein is determined by the sum of the maximum potential drop across two such terminals: one biased, as depicted in FIG. 4B (forming the negative terminal of the energy storage device described further herein), and the other oppositely biased for electron removal (forming the energy storage device's positive terminal).

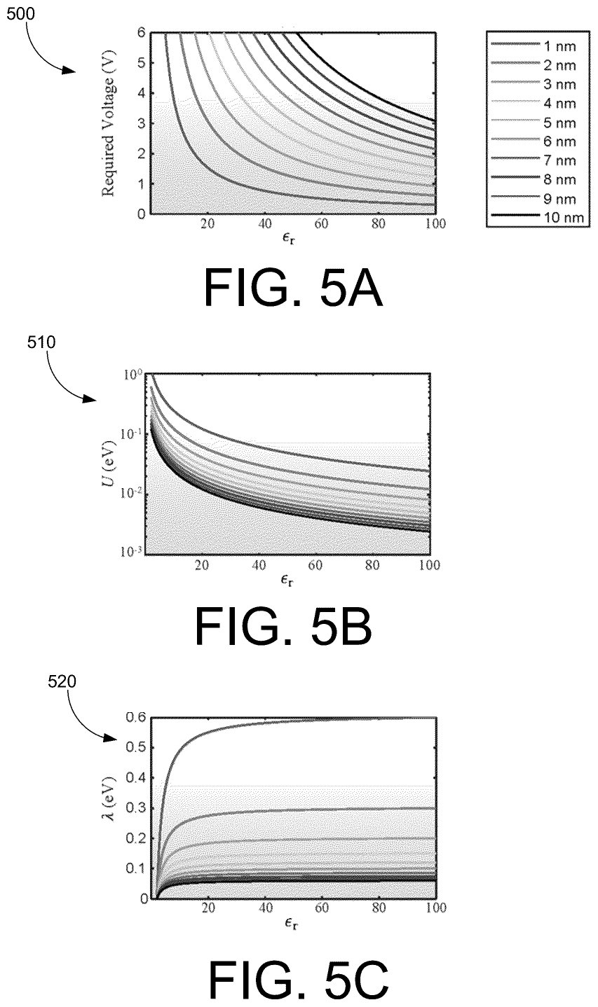

The operational voltage tuning capabilities associated with the energy storage device will now be described. First, it is desirable to arrive at a nanodisk electron storage density of around 4 q/nm² for the proposed energy storage mechanism. Second, it is desirable to tune the charging energy parameter U such that this density of electrons is stored and removed at a bias of about 2.5 V on a given terminal relative to the fully discharged state (for a total of about 5 V across both terminals). From Eqs. (2) and (3), one can see that the solvent dielectric constant (ϵᵣ) and nanodisk radius (r) are two physical means for accomplishing this. In FIG. 5A, the operating voltage at a given terminal is plotted (see plot 500) as a function of the solvent dielectric constant for several nanodisk radii, all storing electrons at a density of σₑ=4 q/nm². The total number of electrons stored in a given disk is πr²σₑ; this can be coupled with Eqs. (2) and (3) to provide the trends in plot 500 of FIG. 5A. Because of the reciprocal relation between ϵᵣ and U in Eq. (3), an increase in ϵᵣ reduces U (see plot 510 in FIG. 5B). This enables a smaller U spacing between consecutive electron transfer peaks, leading to a lower required single electrode voltage V_{-,max} for a targeted density of charge storage (see FIG. 5A). The maximum density of charge that can be stored is determined by the number of counterions that can be packed in to maintain charge neutrality. It may be desirable for U to also be higher than the thermal energy of about k_{B}T. Hence, when tuning the maximum voltage (V_{-,max}), a U value within the range of 0.025 to 0.1 eV is preferable when working to maximize the voltage at a high density of electrons storage. Comparing FIGS. 5A and 5B, one sees that disks with a radii in the range of 3-4 nm within a dielectric medium characterized by ϵᵣ between 40-60 serve well, providing an operating voltage contribution of about 2.5 V per terminal (at σₑ=4 q/nm²) for a total of about 5 V.

The reorganization energy λ of a given particle is also dependent on the radius and dielectric medium of such a nanodisk. Its outer-sphere contribution can be directly computed from Eq. (4) and is plotted as a function of ϵᵣ for various nanodisk radii in plot 520 of FIG. 5C. Here, it is assumed that ϵₒₚ=2. The reorganization energy is important in that it enables a smooth pseudocapacitive current by providing sufficient overlap between many overlapping redox peaks as governed by Eqs. (3) through (7). If λ is too small relative to U, the ability of this mechanism to provide a smooth capacitive voltammetric profile, such as that in FIG. 4A, can become hampered. Hence, it is desirable to maintain λ≥U. From the results in FIG. 5C, this should also be satisfied by nanodisks with radii of 3-4 nm within a dielectric medium characterized by ϵᵣ between 40-60. The reorganization energy is also a contributing factor in the power density performance of the proposed energy storage mechanism.

Lastly, it should be recognized that the classical estimates in FIGS. 5A-C exclude: (1) the screening response and space charge polarization of counterions; and (2) the inner-sphere reorganization response of the solvent electrolyte molecules. Hence, the results in FIGS. 5A-C serve only as an approximate physical estimate. Detailed atomistic calculations may be needed to more accurately compute the combined counterion and molecular-scale contributions to the charging and reorganization energies in a given supporting medium. However, it has been experimentally demonstrated that a charging energy response should be present at the nanoscale in such a system. Hence, the general physical arguments presented should hold—above and beyond system specific details. Overall, the results presented herein are intended to convey the need for tailoring both the dielectric medium and nanodisk dimensionality. Both should be tuned to attain a target electron storage density (per disk) at a given storage voltage via the quantized capacitance mechanism.

The volumetric energy density assessment concludes with electrolyte considerations in quantized capacitance (i.e. a consideration of how electrolyte stability impacts upon energy storage via the mechanism proposed herein). Charge storage via quantized capacitance occurs over two electrodes. One electrode serves as the negative (−) terminal by gaining electrons during charging, while the other serves as the positive (+) terminal by giving up electrons during charging. Since opposite charges are stored on both electrodes, the device's terminals will be biased in opposite directions with respect to their fully discharged configuration. Hence, the overall cell potential in Eq. (1) is the addition of the biases on both electrodes as described by:

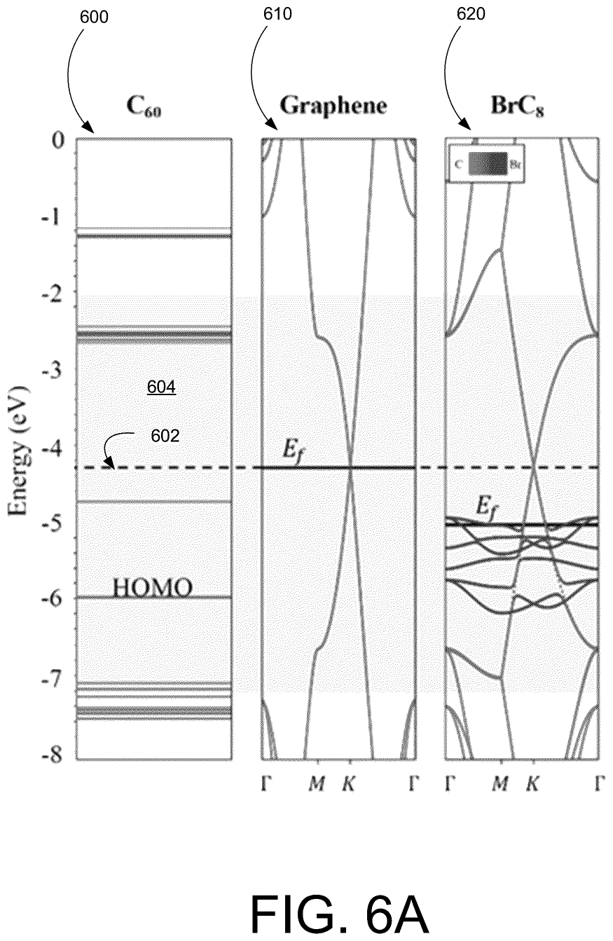

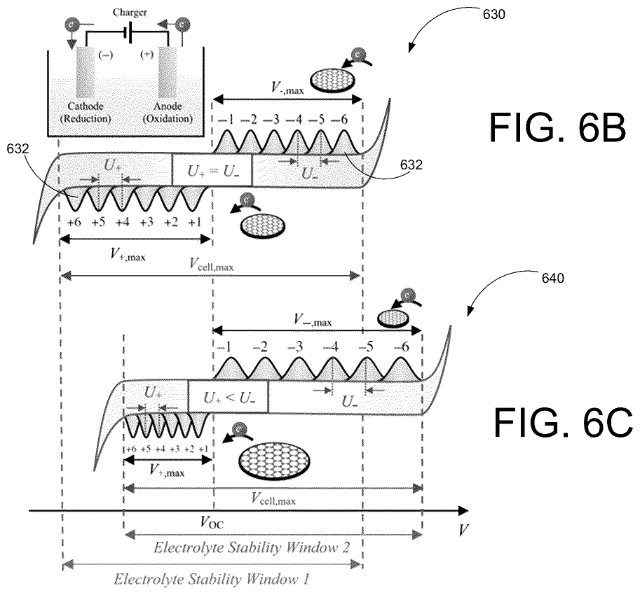

V_{d}=|V_{+,max}|+|V_{-,max}| (8)
where |V_{+,max}| is the maximum applied bias dropping at the positive terminal and |V_{-,max}| is that of the negative terminal (see FIGS. 4A-B). In the simple case of symmetric electrodes, the biases on both electrodes will be approximately equal such that |V_{+,max}|≈|V_{-,max}|≈V_{d}/2 as shown in FIG. 6A. However, it is also possible that the total voltage (V_{d}) in Eq. (8) may be split asymmetrically across two terminals (|V_{+,max}|=|V_{-,max}|) with each storing an equal amount of charge. Following from the results of FIGS. 5A-C, this asymmetric splitting may occur when the nanodisk radius and/or the supporting medium dielectric response is not the same at both electrodes. For example, suppose that the positive (+) terminal has particles twice (two (2) times) the radius than those on the negative (−) terminal. Then, keeping all other system parameters fixed, the positive terminal (+) will only require |V_{+,max}|=|V_{-,max}|/2 to store the same density of electrons (see FIGS. 5A-C). Under this scenario, 2V_{d}/3 would drop across the negative (−) terminal and V_{d}/3 would drop across the positive (+) terminal. More generally, the manner of voltage splitting matters because it can be utilized to maximize energy storage within 435 electrolyte stability constraints.

This voltage splitting arrangement relates directly to how positive and negative charges can be stored. It is well known that carbon nanostructures excel at storing electrons. Indeed, an electron storage density of about 4 q/nm² can be routinely achieved. However, the propensity for electron removal from carbon nanostructures is more challenging. For example, while one can place up to about seven electrons on a C₆₀ molecule, only up to three electrons can typically be removed. Whether one is considering fullerenes or another carbon nanostructure, this difficultly arises when the removal of electrons from the electrolyte (breakdown) occurs at an earlier potential than the removal of further electrons from the intended (carbon) nanostructure. On the other hand, it is possible to attain stability upon removal of high densities of electrons in bulk graphitic systems. For example, in BrC₈ graphite sheets give up to about 4.8 q/nm². More recently, similar success has been found in FeCl₃-doped graphene. Comparatively, in C₆₀ the ratio of electrons that can be removed (even in the presence of counterions) is around one for every 20 atoms, versus one for every eight atoms in BrC₈. The challenge is how to achieve the electron-electron removal capabilities of graphite or graphene in a smaller nanostructure where the V_{+,max} storage voltage can be tuned following the description herein prior to reaching electrolyte breakdown.

The contrasting ability of graphite to give up more electrons than C₆₀ is due to the energies at which electron removal can be accessed. Since electrons are well delocalized in graphene/graphite, the quantization and electron-electron interaction energetic costs associated with electron removal (or addition) are much less than in C₆₀. The comparative electronic structure plots for graphene and C₆₀ in FIG. 6A will be considered for illustrative purposes. In FIG. 6A, the left panel 600 shows the electronic structure of C₆₀, the middle panel 610 that of graphene, and the right panel 620 that of BrC₈ decorated graphene. A dashed line 602 provides the alignment of all electronic structure plots to the Fermi energy (E_{f}) of graphene. The Fermi energy of single-layer BrC₈ lies below that of graphene, due loss of electrons to Br atoms, but above the stability limit of the electrolyte window. Here one can see that the HOMO level of C₆₀ lies about 6 eV below vacuum, while the charge neutrality point (Dirac cone) of graphite or graphene lies at about 5 eV below vacuum as calculated from first principles.

Now, in FIG. 6A, the stability window (see shaded area 604) of a hypothetical electrolyte ranging from −2 to −7 eV below vacuum has been superimposed. This range is chosen for its potential to be realized through electrolyte engineering methods; it has also been placed above band structure plots for graphene and BrC₈ decorated graphene. Clearly, the removal of all such electrons from single-layer BrC₈ lies within the stability window of this electrolyte. However, assuming a charging energy of U=0.3 eV after the removal of about three electrons from C₆₀, one finds that the stability limit of the electrolyte is reached. It is noted that the HOMO-level of C₆₀ is sixfold degenerate. Hence, beyond the HOMO-LUMO gap, only the charging energy contributes to the cost of electron removal of the first six electrons in C₆₀. The point here is that it is the dimensionality of graphite (graphene), being a bulk 2D (3D) materials, that allows a very high density of electrons to be removed with minimal energetic cost (U). This can be seen in the far right single-layer BrC₈ band structure in FIG. 6A, where the Fermi (E_{f}) level lies well above any electrolyte stability considerations. However, in C₆₀ the energetic cost of electron removal (U) is much higher and so much less can be removed at the same potential (or any potential prior to electrolyte breakdown). Thus, the dimensionality of a nanostructure directly impacts on the density of charge it can store prior to reaching the voltage limit at which electrolyte breakdown occurs. Conversely, one can maximize the voltage (prior to electrolyte breakdown) at which a target electron density is removed from graphitic nanostructures (e.g., disks) by tuning their dimensionality (see FIGS. 4A-B). The ability to store more electrons within a fixed bias range with increasing radius (and to do so with high amphoteric propensity) has been experimentally demonstrated in graphene nanoparticles via quantized capacitance.

To overcome these electrolyte stability issues, which compete with the electron storage and removal, multiple engineering avenues for the proposed energy storage system may be possible. First, one may attempt to engineer an electrolyte that has a large stability window that is directly symmetric about the Dirac cone of graphene or graphite (at about 5 eV), as shown in FIG. 6A. In this manner, the charging levels of smaller graphitic nanodisks will also align about the Dirac cone, allowing for the use of symmetrically designed positive and negative terminals with the same disk size, which in turn maximize the storage voltage for the target electron density, as shown in FIG. 6A. The framework for relating the single-particle ionization and affinity energies (such as the “Dirac cone”) in FIG. 6A to voltammetric spectra, such as breakdown voltages relative to a reference electrode, can be found. Promising electrolytes, which might be stable for a wide region about the “Dirac cone” in graphene or graphite may include acetonitrile and/or sulfolane.

Second, one may independently tune the nanodisk dimensions on each electrode to fit a given electrolyte stability window alignment. This scenario is shown in FIG. 6B, where the Dirac cone of graphite or graphene lies closer to the positive breakdown potential of the electrolyte than to its negative breakdown potential. The schematic 630 in FIG. 6B assumes the simple case that V_{OC} lies at the center of the electrolyte stability window with the equally distributed current peaks as in 632 for electron removal at the positive terminal and electron addition at the negative terminal for different charge states on the graphitic nanodisks during a charging process. The equal peak distribution (U₊=U₋) on each terminal is achieved by nanodisks of similar radius on both sides. The inset shows the definition of anode and cathode for a supercapacitor cell under the charging process. In this case, the nanodisk radius on the positive electrode should be larger than that on the negative electrode, so as to store the same density of charge but a lower potential relative to the fully discharged configuration about the Dirac cone energy (see FIG. 6B). Conversely, the nanodisks on the negative electrode can be made smaller to provide a larger voltage window for storing the same density of electrons per disk by realizing a higher charging energy cost (see FIGS. 4A-B). Additionally, one may overcome instability via distinct electrolytes on each terminal discussed in the Supplemental Material. Other approaches to overcome electrolyte stability may exist.

FIG. 6C illustrates a schematic 640 for a more frequently observed V_{OC} that lies closer to the limits for positive electrode. To avoid wasting the wider potential window on the negative electrode, the nanodisks can be engineered to have a smaller radius for a larger U₋ as compared to U₊.

Power density, namely the manner in which the power performance targeted in FIG. 1 might be achieved, will now be addressed. The power density of conventional EDL-based supercapacitors is essentially determined by the diffusion of counterions in the charging and discharging processes. When the ionic diffusion constant reaches around 10⁻¹⁰ to 10⁻⁹ m²/s, these EDL-based systems can achieve high power densities of approximately 10⁴ W/L (see FIG. 1). To match the power density of purely EDL-based supercapacitors as suggested by FIG. 1, it is desirable for a pseudocapacitive mechanism to exhibit fast and reversible redox activity. While the reversibility of a redox system utilizing quantized capacitance is very much determined by the design considerations discussed herein, the rate of redox activity is determined by the speed at which electrons can transfer into and out of nanoparticles. Hence, there are two mechanisms that determine the power density of quantized capacitance as an energy storage medium: (1) counterion diffusion and (2) electron transfer and diffusion. Going forward, it will be assumed that the ionic diffusion engineering issues are similar to either those of conventional EDL-based supercapacitors or organic radical batteries. Instead, the focus will be on the manner in which the electron transfer should also be engineered to maximize the power density of this mechanism (see FIG. 1).

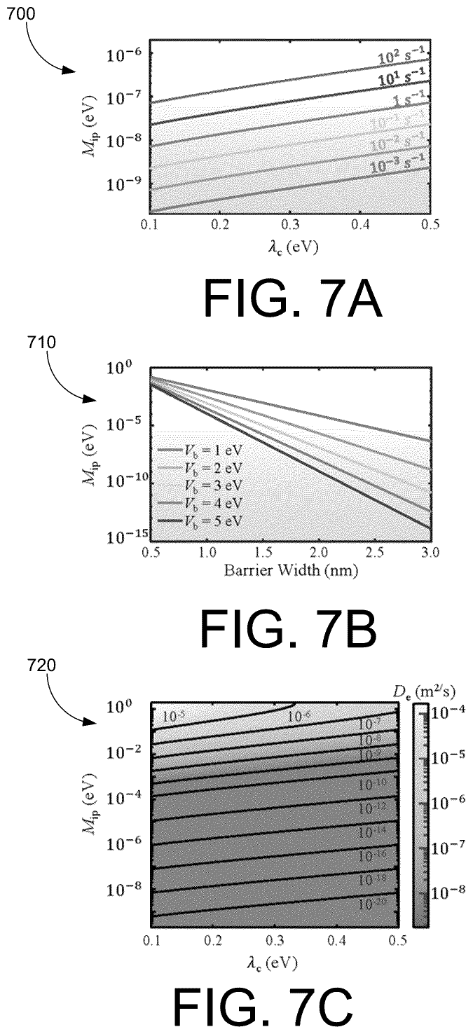

In order for quantized capacitance to persist, it is desirable for particles to be separated by a reasonable tunneling barrier. This is necessary to promote Coulombic interactions between electrons on a nanoparticle and thereby arrive at a “quantized” value of U as described by Eq. (3). By tuning U, one is able to engineer the storage voltage for a target electron density σₑ, as discussed herein. However, this tunneling process cannot be so slow as to render the power density impractical (see FIG. 1). When considering the overall proposed energy storage mechanism, the key limiting factor is the rate at which electrons are transferred between individual particles via tunneling. In the Gerischer-Hopfield description of quantized capacitance, this interparticle electron tunneling (transfer) rate can be approximated as:

$$\begin{matrix}{k}_{ip} = \frac{4 {π}^{2} {\vert {M}_{ip} \vert}^{2}}{h} \int {D}_{red , N + 1} ( ε ) {D}_{ox , N} ( ε ) d ε \\ = \frac{4 {π}^{2} {\vert {M}_{ip} \vert}^{2}}{h} \frac{1}{\sqrt{4 π {λ}_{c} {k}_{B} T}} exp ( \frac{- {λ}_{c}}{4 {k}_{B} T} )\end{matrix} \qquad ( 9 )$$

where |Mᵢₚ| is the electronic coupling between particles, h is Planck's constant, and λ_{c}=2λ is the classical Marcus-Hush reorganization energy. In plot 700 of FIG. 7A, one can see that kᵢₚ depends primarily on both |Mᵢₚ| and λ_{c}. The key assumption in Eq. (9) is that the electrons are weakly coupled such that the transfer mechanism is an outer-sphere (tunneling) process. This intersite electron transfer mechanism is essentially the same as that present in redox-polymer batteries. Now if it is further assumed that the nanodisks in the proposed energy storage device are uniformly spaced, such that the electronic coupling |Mᵢₚ| to all nearest-neighbor particles is approximately the same, then the diffusion of electrons in this system can be approximately written as:

$${D}_{e} = \frac{{i}^{2}}{2 d} {k}_{ip} \qquad ( 10 )$$

where d=3 is the dimensionality of the hopping process and l is the hopping distance.

Assuming that the temperature is held fixed at about 300 K, the interparticle electronic coupling (|Mᵢₚ|) and classical Marcus-Hush reorganization energy (λ_{c}=2λ) primarily dominate the diffusion of electrons via Eqs. (9) and (10). To first order, the electronic coupling is further dependent upon the tunneling barrier width W and height V_{b} between the particles in the manner of:

$$\vert {M}_{ip} \vert \approx 2 \vert {V}_{b} \vert exp ( \frac{- W \sqrt{2 m \vert {V}_{b} \vert}}{ℏ} ) \qquad ( 11 )$$

which is related to the Gamow tunneling expression—m is the electron mass and ℏ=h/2π.

In plot 710 of FIG. 7B it can be seen that both the tunneling barrier height (V_{b}) and width (W) exponentially impact |Mᵢₚ| and thereby impact the electron diffusion rate (Dₑ). The overall magnitude of Dₑ as a function of both |Mᵢₚ| and λ_{c} is plotted in plot 720 of FIG. 7C. It can be seen that to achieve a target electron diffusion constant in the range from about 10⁻¹⁰ to about 10⁻⁹ m²/s, comparable to high performance ionic diffusion, one needs to attain reorganization energies (λ_{c}) in the range from about 0.15 to about 0.25 eV and electronic coupling strengths (|Mᵢₚ|) in the range from about 10⁻² to about 10⁻⁴ eV. Returning to FIG. 5C, one can see that reorganization energies in this range should be easily achievable with ϵᵣ>20. It should be noted that these estimates do not include inner-sphere contributions to the reorganization energy, which should raise their estimate magnitudes further and impact D e. However, the electronic coupling range estimated may be more difficult to achieve from a practical engineering perspective.

Based on the estimates in FIG. 7B, a tunneling barrier with a height of V_{b}=2−3 eV and a width of about 1.2 nm would work best to provide target electron diffusion values in the range 10⁻¹⁰-10⁻⁹ m²/s (see also FIG. 7C). In this system the tunneling barrier is determined by the electrolyte stability window, that is the offset between the liquid electrolyte HOMO and LUMO levels from the nanodisk levels in Eq. (7), and can be manageably engineered. The requirement for maintaining an interdisk separation of about 1.2 nm thick is much more difficult to implement, as it is directly coupled to the volumetric packing of such nanodisks, as previously noted. This somewhat stringent spacing criteria, which excludes any randomness in packing, could likely be alleviated by introducing electron shuttling sites such as buckyballs. Such species could act as intermediate transfer centres to carry electrons between nanodisks that are separated by more than about 1.2 nm, due to packing randomness, and thereby prevent the effective electronic coupling between nanodisks from becoming too low. An interdisk spacing corresponding to about 1.2 nm could also aid the diffusion of counterions by possibly removing the traditional solvation shell limitations. From this perspective, the estimates for optimum packing to promote electron diffusion may also similarly aid counterion diffusion. It should be noted that both electron diffusion and ion diffusion can impact the power density of a pseudocapacitive battery operating via quantized capacitance. This aligns with previously reported findings, where the concerted diffusion of ions and electrons are shown to impact energy performance. However, a conclusive exploration of these issues requires detailed atomistic calculations coupled with careful experimentation.

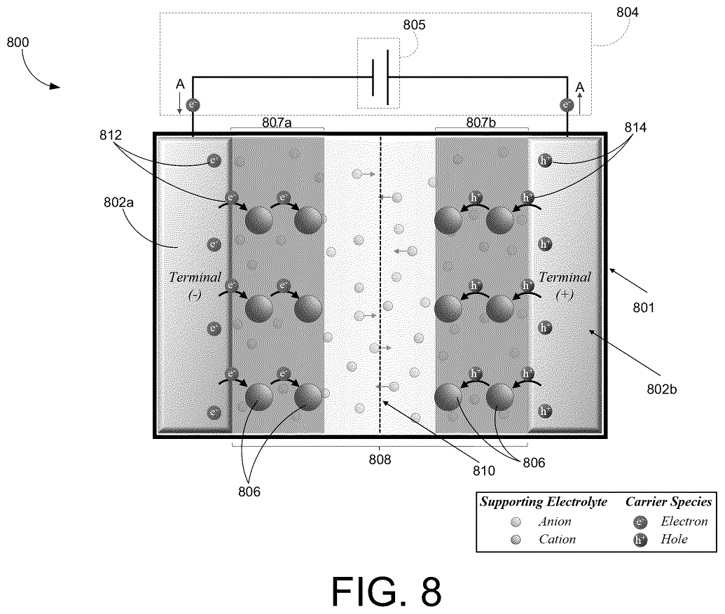

Turning now to FIG. 8, the proposed energy storage device 800 involving Coulomb blockade mechanisms will now be described in further detail, in accordance with one embodiment. The energy storage device 800 comprises a housing 801 within which are positioned a first electrode 802a and a second electrode 802b. One electrode 802a serves as the device's negative (−) terminal by gaining electrons during charging, while the other electrode 802b serves as the positive (+) terminal by giving up electrons during charging.

The two electrodes 802a, 802b of the energy storage device 800 are connected to an external power circuit 804 configured for charging and discharging the device 800. In the illustrated embodiment, the power circuit 804 comprises a battery 805 electrically coupled (e.g., via conductors, or the like) to the electrodes 802a, 802b and configured to supply power to the energy storage device 800 for allowing electrons to flow (e.g., along direction of arrows A when in the charging mode illustrated in FIG. 8, and in the reverse direction in the discharging mode, not shown) within the energy storage device 800. In the embodiment of FIG. 8, the power circuit 804 is illustrated as comprising a battery 805. It should however be understood that this is for illustrative purposes only and that the power circuit 804 may comprise any suitable electrical components including, but not limited to, one or more batteries, resistors, capacitors, or any combination thereof.

At least one of the terminals of the electrodes 802a, 802b of the energy storage device 800 is modified with (i.e. contains) nanostructured materials or elements 806 (e.g., metallic, semi-metallic, conducting, or semi-conducting nanoparticles) to enable the Coulomb blockade mechanism. In some embodiments, the nanostructured materials 806 are arranged to form nanoparticle layers 807a, 807b that are positioned adjacent the terminals of electrodes 802a, 802b, respectively, for energy storage. Although FIG. 8 illustrates an energy storage device 800 in which both terminals are modified with nanostructured materials 806, it should be understood that only one of the terminals associated with the electrodes 802a, 802b (e.g., the positive terminal only or the negative terminal only) may be modified with the nanostructured materials 806 to achieve Coulomb blockage. For example, the negative terminal (at electrode 802a) may be so modified and the opposite terminal (e.g., the positive terminal at electrode 802b) may exploit other storage mechanisms than Coulomb blockade.

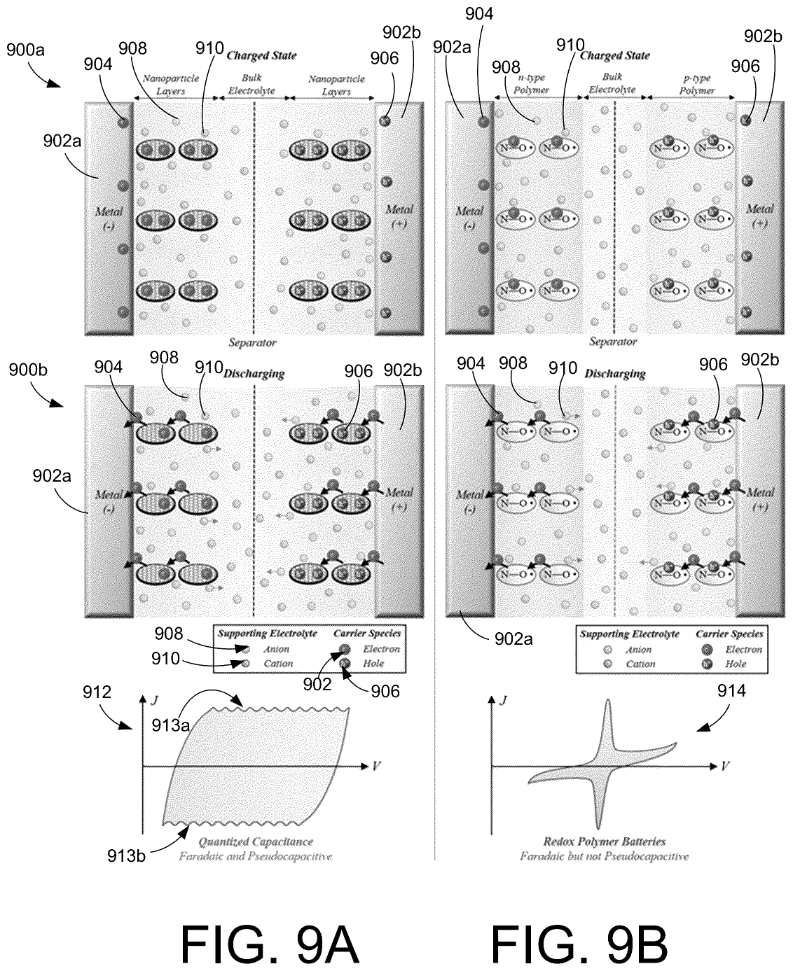

Furthermore, in some embodiments, the Coulomb blockade effect may be a standalone storage mechanism or operate in conjunction with other storage mechanisms. For instance, the energy storage device described herein (e.g., device 800 of FIG. 8 or device 900a of FIG. 9A) could have a variation where the nanostructured materials as in 806 may contain mixtures of other storage materials (e.g., ultracapacitor materials) and blockade nanostructures.

Still referring to FIG. 8, the electrodes 802a, 802b are in contact with a supporting medium 808. The supporting medium 808 is disposed in the volume defined between the spaced electrodes 802a, 802b and may be a dielectric or electrolytic medium. The supporting medium 808 contains at least one charged (positive and negative) species, i.e. cations and anions, which may permeate into the nanostructured materials 806. In particular, the supporting medium 808 comprises at least one counterion species (i.e. cations and anions) of charge opposite to the charge stored. As used herein, the term “counterion” refers to an ion that accompanies an ionic species in order to maintain electric neutrality.

A separating member 810 (also referred to herein as a “separator”) may be positioned in the supporting medium 808, at a substantially equal distance (not shown) from the electrodes 802a, 802b. The separating member 810 is configured to prevent the electrodes 802a, 802b from coming into electrical contact with one another, thus preventing short-circuiting of the terminals of the electrodes 802a, 802b. The separating member 810 is preferably made of a porous material to allow anions and cations present in the supporting medium 808 to pass through the separating member 810. In some embodiments, the separating member 810 is a polymer matrix. In other embodiments, the separating member 810 is a filter paper. Any other suitable porous material may apply. While FIG. 8 illustrates the energy storage device 800 as comprising a distinct separating member 810, it should be understood that the separating member 810 may or may not be present in the energy storage device 800, depending on the type of supporting medium 808. For example, in some embodiments, the supporting medium 808 may itself act as a separator between the terminals of the electrodes 802a, 802b, without the need for a distinct separating member 810.

Each electrode 802a, 802b further comprises a current collector (not shown) configured to conduct and bridge the flow of electrons 812 between the supporting medium 808 and the terminals of the electrodes 802a, 802b. The nanostructured materials 806 may be deposited directly on the respective current collector or deposited onto a conductive material (not shown) coated onto the respective current collector. The current collector at the negative terminal of electrode 802a receives electrons 812 under the potential bias such that the electrons 812 can tunnel and be stored in the nanostructured materials 806. The opposite (i.e. positive) terminal of electrode 802b exhibits the reverse process of extracting the electrons 812 (depicted as holes 814 in FIG. 8). In one embodiment, electrons 812 may be transferred from the current collector to the nanostructured materials 806 for negative charge storage during the charging process, and the electrons 812 may be transferred from the nanostructured materials 806 to the current collector during the discharging process. In another embodiment, the electrons 812 may be transferred from the nanostructured materials 806 to the current collector for positive charge storage during the charging process, and the electrons 812 may be transferred from the current collector to the nanostructured materials 806 during the discharging process. Due to these electron transfers, the ionic species in the supporting medium 808 can drift and diffuse to screen the potential.

It should be understood that, while the nanostructured materials 806 are illustrated as having a spherical shape in FIG. 8, this is for sake of simplicity. The shape and size of the nanostructured materials 806 may indeed vary because various suitable nanostructured material candidates can exhibit Coulomb blockade mechanisms. In other words, the nanostructured materials 806 may take any suitable size, shape, form, and overall configuration, as will be described further below. In one embodiment, the nanostructured materials 806 have a size distribution lower than 100 nm, i.e. penetrate into a range of size lower than 100 nm. As used herein, the term “size distribution” refers to the average size of the nanoparticles employed that exhibit quantized capacitance. The average size refers to the range or spread of the measurement of one or more dimensions of the nanostructured materials 806. As previously noted, the nanostructured materials 806 may be conducting or semi-conducting and may consist of carbon elements (as will be described further below), semi-metallic elements, and/or metallic elements.

In one embodiment illustrated in FIG. 9A and FIG. 9B, the energy storage device may be constructed using carbon nanodisks as the nanoparticle materials used to exploit Coulomb blockade mechanisms on both positive and negative terminals of the energy storage device. In FIG. 9A, the fully charged configuration within the proposed energy storage scheme is provided in schematic 900a, where the negative electrode (or terminal) 902a holds electrons (e⁻) 904 taken from the positive electrode 902b to leave behind holes (h⁺, the absence of an electron) 906. It is desirable for screening counterions (i.e. anions, cations) to be present within both electrodes 902a, 902b in equal concentration to their stored charges (i.e., anions 908 and cations 910 in FIG. 9A), to prevent the onset of Coulomb explosion. Likewise, the discharging state is illustrated in schematic 900b of FIG. 9A, where electrons 904 placed on the negative electrode (or terminal) 902a move back to the positive electrode (or terminal) 902b and counterions 908, 910 diffuse accordingly in the opposite direction.

Apart from the use of quantized graphitic nanoparticles, the scheme in FIG. 9A is operationally quite similar to that of a redox-polymer battery as juxtaposed in FIG. 9B. The two schemes are analogous in several respects: (1) redox processes occur throughout both the positive and negative terminal charging media; (2) electrons are stored on the negative terminal 902a and holes on the positive terminal 902b; (3) the diffusion of electrons 904 and holes 906 is facilitated by intersite electron transfer; and (4) counterions 908, 910 are allowed to freely diffuse to prevent the onset of Coulomb explosion. However, the use of quantized nanoparticles enables two key additional features: (1) the charge stored at a given voltage can be tuned through dimensionality engineering; and (2) multiple redox events occur at each site through the use of quantized capacitance. This latter difference enables a near “ideal” pseudocapacitive behavior in such nanoparticles, in direct contrast to the peaked voltammetric behavior found in a redox polymer battery—contrast the lower voltammogram 912 in FIG. 9A with the lower voltammogram 914 in FIG. 9B. Indeed, one might consider the proposed mechanism in FIG. 9A to be that of a “pseudocapacitive battery.”

It should be noted that the shape of the voltammogram 912 (and more particularly that of the upper and lower portions thereof) may vary, depending on the separation U between the overlapping electron transfer current peaks (see FIG. 4A). In particular, when the separation U is large, such that the peaks are widely spaced apart together, the upper and lower portions of the voltammogram 912 may exhibit waves or wiggles as shown by the wavy lines 913a, 913b of FIG. 9A. In contrast, when the separation U is small, such that the peaks are close together, the upper and lower portions of the voltammogram 912 may be substantially flat (not shown). As noted previously, the nanostructured materials (reference 806 in FIG. 8) may have any suitable configuration other than nanodisks. For example, the configuration of the nanostructured materials 806 may include, but is not limited to, spherical (as illustrated in FIG. 8), disk, dot, cubic, polygon, start, flower, tube, rod, ribbon, strip, plate, string, sheet, crystalline layer, lattice, layered, crystalline, amorphous, core-shell, micelles, branched, dendrite, grafted, protein, and polymer. The nanostructured materials 806 may also assume a design resulting from mixing or combining any of the previously-noted variations. For example, star-shaped nanoparticles within spherical cages, a mixture of polygonal and spherical nanoparticles, or amorphous nanoparticles with partially crystalline structures may apply. In some cases, it is possible for nanostructured materials 806 to agglomerate or contain defects. It is also possible to have more than one type of nanostructured materials 806 exhibiting quantized capacitance in a given energy storage device.

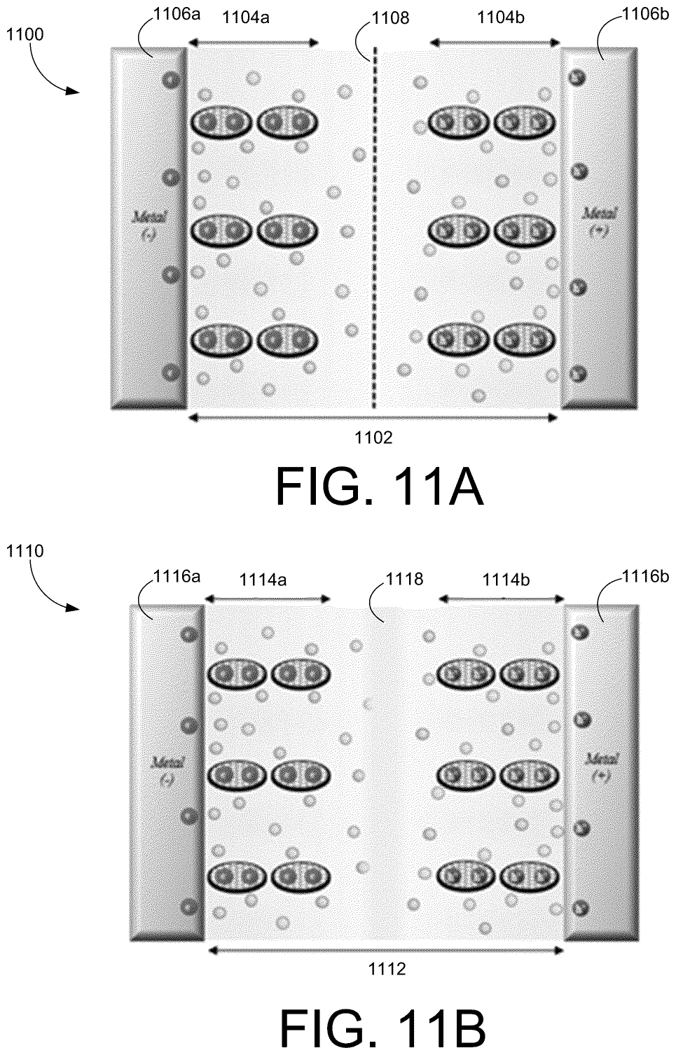

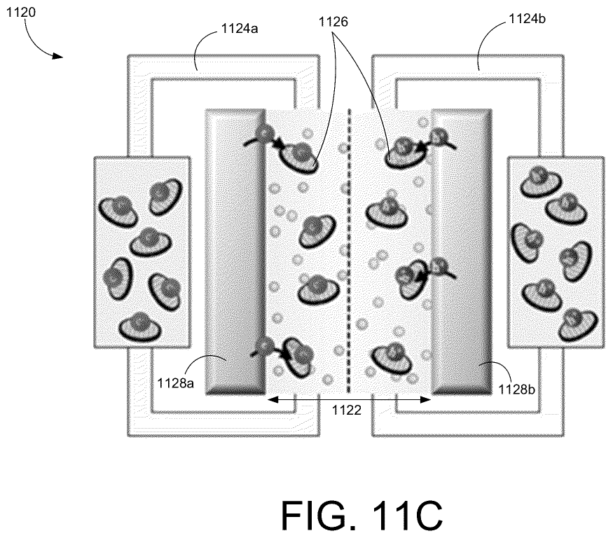

Furthermore, the volume region (i.e. the supporting medium, reference 808 in FIG. 8) envisioned for packing and dispersing the nanostructured materials 806 to utilize Coulomb blockade mechanisms may vary. To enable Coulomb blockade mechanisms, it is desirable for the nanostructured materials 806 (i.e. the nanoparticles or nanostructures) to be sufficiently separated from each other to enable electron tunneling and storage. This can be achieved with non-conducting materials (including, but not limited to, grafting, molecules, core-shell structures, micelles or solvation species, layered structures, ligands, and functional groups), dispersion in the volume or surface area (including, but not limited to, polymer, doping, dispersion in liquid or solution, depositing, templating, and printing), segregation by defects (such as dislocations and grain boundaries), or the combinations of these methods. In some cases, conducting materials (e.g., sheets, ribbons, tubes, or the like) can be provided to act as electron conductors to promote electron transport into the supporting medium hosting the nanostructured materials 806. In some cases, layering or depositing structures with blockaded nanoparticles may assist electron transport. The structuring of layering or deposited sheets may also be employed with blockade nanoparticles to combine ultracapacitor energy storage with blockaded energy storage in a hybrid context in the same terminal of the energy storage device. In some cases, it is possible for the nanostructured materials 806 to not be deposited to the device's terminals directly. For example, the nanostructured materials 806 may be dispersed in electrolytic media as in a flow battery depicted in FIG. 11C, or deposited on other structures connected to the device's terminals as described further below.

Moreover, it should be understood that any suitable supporting medium 808 may apply. In one embodiment, an electrolytic media having the simplified construction of FIG. 8 may be used. However, this is for illustrative purposes only and the actual energy storage device as in 800 may be built in different form factors including, but not limited to, cylindrical, prismatic, pouch, coin cell, flexible cell, flow cell, woven cell, and printed cell. Different variations and types of supporting medium 808 (e.g., electrolytic media) may thus be used to enable the Coulomb blockade energy storage mechanism. The electrolytic media used as the supporting medium 808 may be a medium in liquid state, solid state, or any combination thereof. Liquid electrolytic media that may apply includes, but is not limited to, aqueous (e.g., acidic electrolyte, basic electrolyte, or neutral electrolyte), non-aqueous, ionic liquids, redox active electrolytes, and mixtures. Solid electrolytic media that may apply includes, but is not limited to, dry solid polymer, gel polymer, hydrogel, inorganic solid, organic media, composite, oxide media, ceramic media, and quasi-solid ionic. The electrolytic media may also be a combination of liquid and solid media, such as a solid polymer soaked with liquid electrolyte, liquid crystal, and the like.

It should be noted that the energy storage device's housing (reference 801 in FIG. 8) may be used to contain the supporting medium 808 made of liquid media, while the housing 801 may or may not be necessary for the solid media. In all supporting medium 808 (i.e. all electrolytic media), the presence of charged species is used to screen the potential within both electrodes of the device 800. These charged species for electrostatic screening can consist of ionic species, charged species, molten species, dipole species, polarizable species, or mixture thereof. It is possible for the electrolytic media to penetrate the nanostructured materials 806 (i.e. the nanoparticle or nanostructure volumes). It is possible for the electrolytic media to have various pH, stability window, and physical states such as solid, liquid, or an intermediate between these two phases. It is also possible for the electrolytic media to contain additives or other materials.

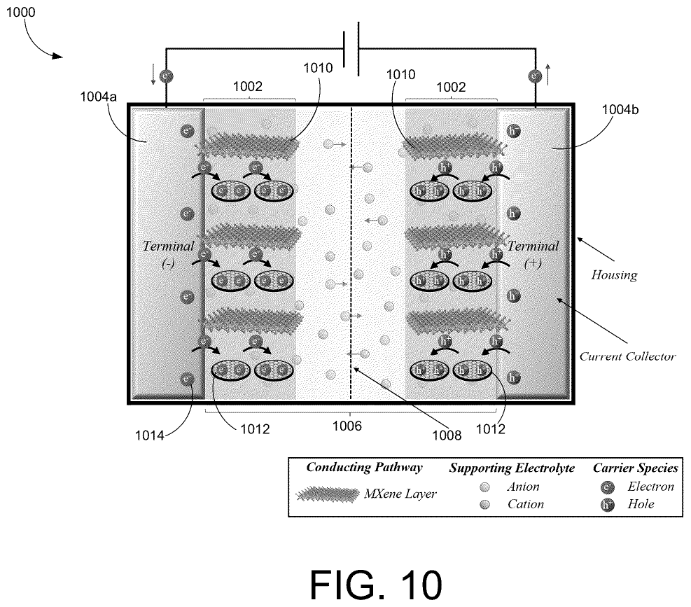

Referring now to FIG. 10, in yet other embodiments, the nanostructured materials (reference 806 in FIG. 8) may be interspersed with sheets and/or filaments of conductive material. A conductive MXene may be used as the conductive material. It should however be understood that any suitable conductive material other than a MXene may apply. This embodiment is illustrated in FIG. 10, which is a schematic diagram of an exemplary energy storage device 1000 (shown in the charged state) using stacked MXene composite layers 1002. The MXene composite layers 1002 are positioned adjacent the terminals of respective electrodes 1004a, 1004b and are separated by electrolyte media 1006. In the illustrated embodiment, the energy storage device 800 further comprises a separating member 1008. The MXene composite layer 1002 comprises a network of conductive material forming an interconnected structure having any suitable configuration. In one embodiment, each MXene composite layer 1002 comprises a plurality of MXene sheets 1010 that separate nanostructured materials 1012, which are illustrated as nanodisks in FIG. 10. In other words, each stacked MXene composite layer 1002 can be achieved by embedding nanostructured materials 1012 (e.g., nanodisks) between the MXene sheets 1010 (i.e. distributing the nanostructured materials 1012 in a space defined between adjacent MXene sheets 1010). This may in turn tune the inter-layer width of the MXene composite layer 1002 in order to optimize fast ionic diffusion. The illustrated configuration may allow to facilitate the transfer of electrons 1014. Such a configuration may also provide hybrid charge storage on the sheets and/or filaments through counter-ion double layer formation or direct adsorption.

In one embodiment, the MXene sheets 1010 of the MXene composite layer 1002 are vertically aligned, as illustrated in FIG. 10. It should however be understood that the MXene sheets 1010 may be arranged in any suitable manner provided the MXene sheets 1010 form a mesh of pathways to optimize ionic diffusion. For example, rather than being vertically aligned, the MXene sheets 1010 may have a random orientation. Other embodiments may apply. It should also be understood that the MXene composite layer 1002 may comprise any suitable network of conductive material other than sheets.

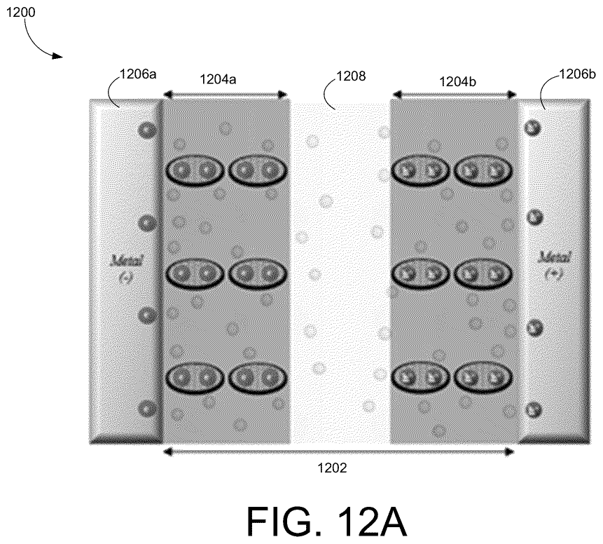

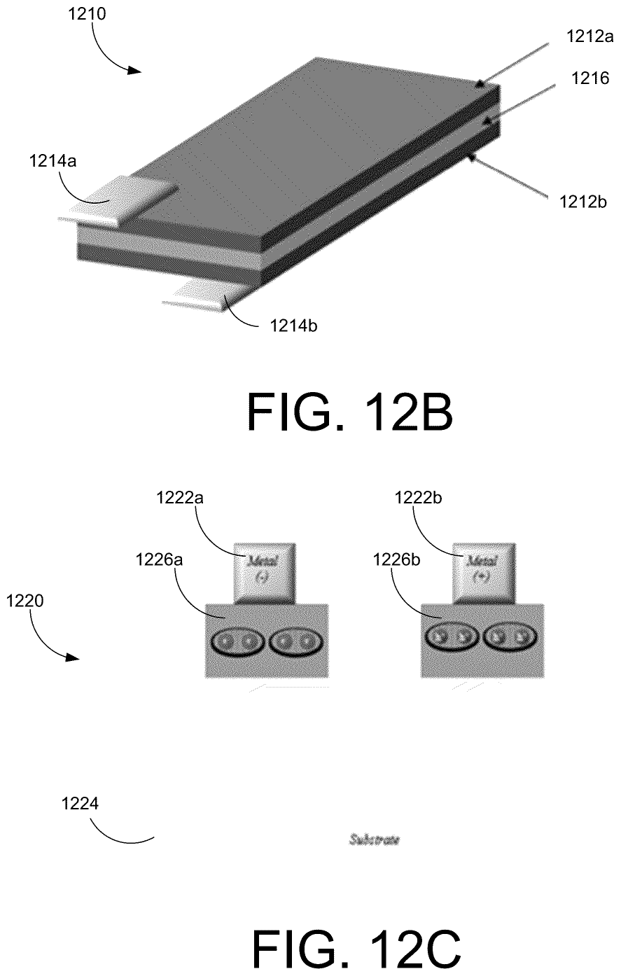

Referring now to FIGS. 11A, 11B, 11C, 12A, 12B, and 12C, some further variations to the construction of the proposed energy storage device are illustrated, in accordance with some embodiments. FIGS. 11A, 11B, and 11C illustrate liquid state configurations while FIGS. 12A, 12B, and 12C illustrate solid state configurations.

First, it should be noted that the electrolytic media containing the nanostructured materials (reference 806 in FIG. 8) may comprise of two volumes of electrolytic media (each containing a plurality of the nanostructured materials 806) that may or may not be composed of the same electrolyte medium. FIG. 11A illustrates an embodiment of an energy storage device 1100 that has a supporting medium 1102 made of two (2) different electrolytes. As such, the nanoparticle layers 1104a, 1104b respectively provided adjacent terminals of electrodes 1106a, 1106b are contained in different electrolytes (rather than the same electrolyte as illustrated in FIG. 8 for instance), with a separator 1108 in between. FIG. 11B illustrates an embodiment of an energy storage device 1110 having a supporting medium 1112 made of an immiscible electrolyte. In this embodiment, the nanoparticle layers 1114a, 1114b provided adjacent the respective terminals of electrodes 1116a, 1116b do not mix and are separated by a separator 1118 formed by a mixed layer of the immiscible electrolyte media. FIG. 11C illustrates an embodiment of an energy storage device 1120 having a flow electrolyte configuration (i.e. operates as a flow battery), in which the supporting medium 1122 is a non-static liquid electrolyte medium made of two distinct volumes 1124a, 1124b. As a result, the nanoparticle elements 1126 are dissolved in the supporting medium 1122 rather than deposited on current collectors of the electrodes 1128a, 1128b. The nanoparticle elements 1126 are therefore floating in the volumes 1124a, 1124b of the supporting medium 1122 and are displaceable therein to enable electron flow and charge storage. It should be understood that the nanoparticle elements 1126 may be floating in the volumes 1124a, 1124b whether the supporting medium 1122 is static or non-static.

FIG. 12A illustrates an embodiment of an energy storage device 1200 having a rigid form factor. In this embodiment, the energy storage device 1200 comprises a supporting medium 1202 that is made of ceramic media. Nanoparticle layers 1204a, 1204b are provided adjacent the respective terminals 1206a, 1206b and separated by a middle layer 1208 made of any suitable rigid material including, but not limited to, metal, dry polymer, and solid polymer. In contrast, FIG. 12B illustrates an embodiment of an energy storage device 1210 having a flexible form factor. In this embodiment, the energy storage device 1210 comprises nanoparticle layers 1212a, 1212b provided adjacent respective metal terminals 1214a, 1214b and separated by a separating electrolytic layer 1216. The separating layer 1216, along with the nanoparticle layers 1212a, 1212b, may be made of any suitable material allowing flexibility (i.e., bending, stretching, and the like) of the device 1200. In one embodiment, the separating layer 1216 is made of polymeric electrolyte media. FIG. 12C illustrates an embodiment of an energy storage device 1220 formed through printing (also referred to as templating or depositing). This may allow the resulting energy storage device 1220 to have a miniaturized form factor. In this embodiment, components of the energy storage device 1220 are printed onto a substrate 1224. More particularly, the device's negative and positive terminals 1222a, 1222b are printed onto the substrate 1224, adjacent respective nanoparticle layers 1226a, 1226b. It should however be understood that the pattern and design of the templated or deposited device may vary depending on the applications.

While the embodiments of FIGS. 11A, 11B, 11C, 12A, 12B, and 12C are depicted with carbon nanodisks used as the nanostructured materials, it should be understood that the nanostructured materials may have many variations, as described herein above. It should also be noted that, in some cases, it may be possible for the energy storage device to couple with other energy storage mechanisms such as blockade electrode with air electrode or plasmonic electrode.

It should also be noted that there is a possibility of combining the proposed quantized capacitance setup within other emerging EDL technologies. For example, rather than utilizing a single electrode setup, a matrix of nanodisks could be imbedded between stacked electrically conductive MXenes sheets or similarly electrically conductive materials, as illustrated in FIG. 10. The nanodisk matrix would add a Faradaic storage component to such a supercapacitor system. Likewise, vertically aligned MXene layers would also aid fast ionic diffusion. In this manner, two such technologies might complement each other to improve overall performance. Similar hybrid approaches could be applied with other supercapacitor systems. Even a slurry-type redox flow battery utilizing quantized capacitance to access multiple redox states is plausible.

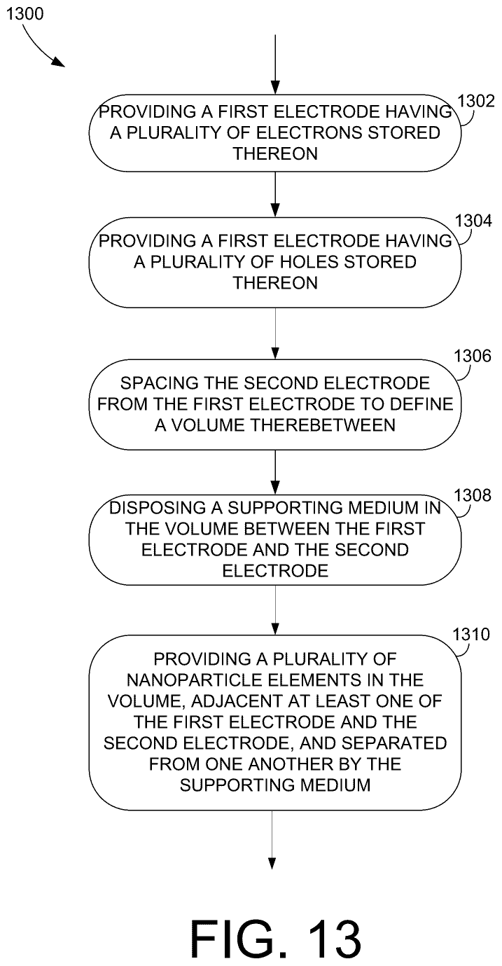

Referring now to FIG. 13, a method 1300 for providing an energy storage device, such as the device 800 of FIG. 8, will now be described. The method 1300 comprises, at step 1302, providing a first electrode having a plurality of electrons stored thereon, and at step 1304, providing a second electrode having a plurality of holes stored thereon. Step 1306 comprises spacing the second electrode from the first electrode to define a volume therebetween. Step 1308 comprises disposing a supporting medium in the volume between the first electrode and the second electrode. Step 1310 comprises providing a plurality of nanoparticle elements in the volume, adjacent at least one of the first electrode and the second electrode, and separated from one another by the supporting medium. The plurality of nanoparticle elements are configured to store the electrons therein at different energy levels. The supporting medium and the nanoparticle elements may have any suitable configuration, as described herein.

In both the proposed energy storage device and existing technologies, such as redox-polymer batteries, redox centres are dispersed in a supporting medium, with operation facilitated by the classical diffusion of counterions and the tunneling (outer-sphere transfer) diffusion of electrons. Unlike redox-polymer batteries, quantized capacitance is capable of producing multiple redox reactions on a single site, in such a manner that the Faradaic current is able to mimic a pseudocapacitive response as shown in FIGS. 4A-B. As previously noted, the proposed mechanism can thus be considered as a “pseudocapacitive battery”—though quantized capacitance is not limited to carbon-based nanoparticles.

Returning to the Ragone plot 100 in FIG. 1, it can be seen that quantized capacitance may be engineered to combine the power performance of supercapacitors with the energy density of battery systems. Quantized capacitance may yield an energy density of 100 Wh/L combined with a power density of 10⁴ W/L.

The above description is meant to be exemplary only, and one skilled in the art will recognize that changes may be made to the embodiments described without departing from the scope of the invention disclosed. Still other modifications which fall within the scope of the present invention will be apparent to those skilled in the art, considering a review of this disclosure.

Various aspects of the systems and methods described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although embodiments have been shown and described, it will be apparent to those skilled in the art that changes, and modifications may be made without departing from this invention in its broader aspects. The scope of the following claims should not be limited by the embodiments set forth in the examples but should be given the broadest reasonable interpretation consistent with the description.

What is claimed is:

1. An energy storage device, comprising:
a first electrode having a plurality of electrons stored thereon;
a second electrode having a plurality of holes stored thereon, the second electrode spaced from the first electrode to define a volume therebetween;
a supporting medium disposed in the volume between the first electrode and the second electrode, the supporting medium comprising at least one counterion species; and
a plurality of nanoparticle elements provided in the volume, adjacent at least one of the first electrode and the second electrode, the plurality of nanoparticle elements configured to store the electrons therein at different energy levels using quantized capacitance.

2. The energy storage device of claim 1, wherein the plurality of nanoparticle elements are made of at least one of carbon, semi-metallic elements, semiconducting elements, and metallic elements.

3. The energy storage device of claim 1, wherein each nanoparticle element of the plurality of nanoparticle elements has a size distribution lower than 100 nm.

4. The energy storage device of claim 1, wherein each of the first electrode and the second electrode comprises a current collector, and further wherein the plurality of nanoparticle elements are deposited onto the current collector of at least one of the first electrode and the second electrode.

5. The energy storage device of claim 1, wherein at least one of the first electrode and the second electrode comprises a current collector coated with a conductive material, and further wherein the plurality of nanoparticle elements are deposited onto the conductive material.

6. The energy storage device of claim 1, wherein the plurality of nanoparticle elements are embedded or dispersed in the supporting medium.

7. The energy storage device of claim 1, wherein the supporting medium is one of an electrolytic medium and a dielectric medium.

8. The energy storage device of claim 1, wherein the supporting medium is in at least one of a liquid state and a solid state.

9. The energy storage device of claim 1, wherein the supporting medium is an immiscible electrolyte.

10. The energy storage device of claim 1, wherein the supporting medium is one of static and non-static.

11. The energy storage device of claim 1, wherein the plurality of nanoparticle elements are configured to be displaced within the supporting medium.

12. The energy storage device of claim 1, wherein the first electrode and the second electrode are printed onto a substrate.

13. The energy storage device of claim 1, wherein the first electrode, the second electrode, and the supporting medium are made of a flexible material.

14. The energy storage device of claim 1, wherein the plurality of nanoparticle elements are separated from one another by the supporting medium.

15. The energy storage device of claim 1, wherein the plurality of nanoparticle elements comprises a first plurality of nanoparticle elements and a second plurality of nanoparticle elements, further comprising a separating member disposed within the volume at a substantially equal distance from the first electrode and the second electrode, the separating member configured to separate the first plurality of nanoparticle elements from the second plurality of nanoparticle elements.

16. The energy storage device of claim 1, further comprising a network of conductive material provided within the volume between the first electrode and the second electrode, wherein the plurality of nanoparticle elements are distributed within the network of conductive material.

17. A method for providing an energy storage device, the method comprising:
providing a first electrode having a plurality of electrons stored thereon;
providing a second electrode having a plurality of holes stored thereon;
spacing the second electrode from the first electrode to define a volume therebetween; disposing a supporting medium in the volume between the first electrode and the second electrode; and
providing a plurality of nanoparticle elements in the volume, adjacent at least one of the first electrode and the second electrode, and separated from one another by the supporting medium, the plurality of nanoparticle elements configured to store the electrons therein at different energy levels.

18. The method of claim 17, wherein providing the plurality of nanoparticle elements in the volume comprises depositing the plurality of nanoparticle elements onto a current collector of at least one of the first electrode and the second electrode.

19. The method of claim 17, wherein providing the plurality of nanoparticle elements in the volume comprises depositing the plurality of nanoparticle elements onto a conductive material coated on a current collector of at least one of the first electrode and the second electrode.

20. The method of claim 17, wherein providing the plurality of nanoparticle elements in the volume comprises providing a network of conductive material within the volume, and distributing the plurality of nanoparticle elements within the network of conductive material.
